(19) United States
(12) Patent Application Publication
(10) Pub. No.: US 2026/0034885 A1
(43) Pub. Date: Feb. 5, 2026

(54) IN-VEHICLE DEVICE AND NON-TRANSITORY STORAGE MEDIUM

(71) Applicant: TOYOTA JIDOSHA KABUSHIKI KAISHA, Toyota-shi (JP)

(72) Inventor: Yu NAGATA, Chofu-shi (JP)

(73) Assignee: TOYOTA JIDOSHA KABUSHIKI KAISHA, Toyota-shi (JP)

(21) Appl. No.: 19/239,570

(22) Filed: Jun. 16, 2025

(30) Foreign Application Priority Data
Jul. 31, 2024 (JP) 2024-124875

(51) Int. Cl. B60K 35/81; B60K 35/28; B60K 35/65; B60W 50/00; B60W 50/14; G06V 20/59; G06V 40/10

(52) U.S. Cl. CPC B60K 35/81; B60K 35/28; B60K 35/65; B60W 50/14; G06V 20/59; G06V 40/10; B60K 2360/573; B60K 2360/731; B60K 2360/741; B60W 2050/0083; B60W 2050/146; B60W 2420/403; B60W 2540/227

(57) ABSTRACT

The in-vehicle device according to one aspect of the present disclosure acquires an image from an imaging device disposed toward the interior of the vehicle, identifies a current status of a user present in the vehicle by analyzing the acquired image, determines a display format of a two-dimensional code according to the identified current status and displays the two-dimensional code on a display according to the determined display format.

### CROSS REFERENCE TO THE RELATED APPLICATION

This application claims the benefit of Japanese Patent Application No. 2024-124875, filed on Jul. 31, 2024, which is hereby incorporated by reference herein in its entirety.

### BACKGROUND

### Technical Field

The present disclosure relates to an in-vehicle device and a program.

### Description of the Related Art

Japanese Patent Laid-Open No. 2011-039073 proposes an electronic device that displays information about a spot that is the subject of information provision using a two-dimensional code.

### SUMMARY

An object of the present disclosure is to provide a technique for improving the readability of two-dimensional code.

An in-vehicle device according to the first aspect of the present disclosure includes a controller. The controller configured to execute acquiring an image from an imaging device disposed toward an inside of a vehicle, identifying a current status of a user present in the vehicle by analyzing the acquired image, determining a display format of a two-dimensional code according to the identified current status and displaying the two-dimensional code on a display according to the determined display format.

A non-transitory storage medium according to the second aspect of the present disclosure stores a program for causing an in-vehicle device to execute an information processing method. The information processing method includes acquiring an image from an imaging device disposed toward an inside of a vehicle, identifying a current status of a user present in the vehicle by analyzing the acquired image, determining a display format of a two-dimensional code according to the identified current status and displaying the two-dimensional code on a display according to the determined display format.

According to the present disclosure, the readability of the two-dimensional code can be improved.

### BRIEF DESCRIPTION OF THE DRAWINGS

FIG. 1 schematically shows an example of a situation in which the present disclosure is applied;

FIG. 2 schematically shows an example of a scene in which the display format of a two-dimensional code is controlled;

FIG. 3 schematically shows an example of a scene in which the display format of a two-dimensional code is controlled;

FIG. 4 schematically shows an example of a scene in which the display format of a two-dimensional code is controlled;

FIG. 5 schematically shows an example of the hardware configuration of the in-vehicle device of the present disclosure; and

FIG. 6 is a flowchart illustrating an example of a processing procedure related to the display of a two-dimensional code by an in-vehicle device of the present disclosure.

### DESCRIPTION OF THE EMBODIMENTS

In conventional methods, two-dimensional codes are displayed in a fixed area. However, the two-dimensional code displayed in a fixed area is not always easy to read in the vehicle. For example, the position that is easy to read is different when a passenger sitting in the passenger seat reads a two-dimensional code and when a driver in the driver's seat reads a two-dimensional code. Therefore, in the conventional method, the displayed two-dimensional code may be difficult for the user to read.

On the other hand, the In-vehicle device according to the first aspect of the present disclosure includes a controller. The controller configured to execute acquiring an image from an imaging device disposed toward an inside of a vehicle, identifying a current status of a user present in the vehicle by analyzing the acquired image, determining a display format of a two-dimensional code according to the identified current status and displaying the two-dimensional code on a display according to the determined display format.

In the first aspect of the present disclosure, the current status in the vehicle is identified from the imaging image obtained by the imaging device, and the display format of the two-dimensional code is determined according to the identified current status. As a result, depending on the current status in the vehicle, the display format of the two-dimensional code can be controlled. By controlling the display format of the two-dimensional code, it is possible to display a two-dimensional code suitable for the situation inside the vehicle, such as displaying the two-dimensional code at a position close to the user. Therefore, according to the first aspect of the present disclosure, the readability of the two-dimensional code can be improved.

As another form of the in-vehicle device according to the above aspects, one aspect of the present disclosure may be an information processing method that realizes all or part of each of the above components, a program, or a machine such as a computer that stores such a program. Here, a machine-readable storage medium is a medium in which information such as a program is stored by an electrical, magnetic, optical, mechanical or chemical action.

For example, a non-transitory storage medium according to the second aspect of the present disclosure stores a program. The program includes a series of instructions that cause the in-vehicle device to perform an information processing method. The information processing method includes acquiring an image from an imaging device disposed toward an inside of a vehicle, identifying a current status of a user present in the vehicle by analyzing the acquired image, determining a display format of a two-dimensional code according to the identified current status and displaying the two-dimensional code on a display according to the determined display format.

### 1 Application Example

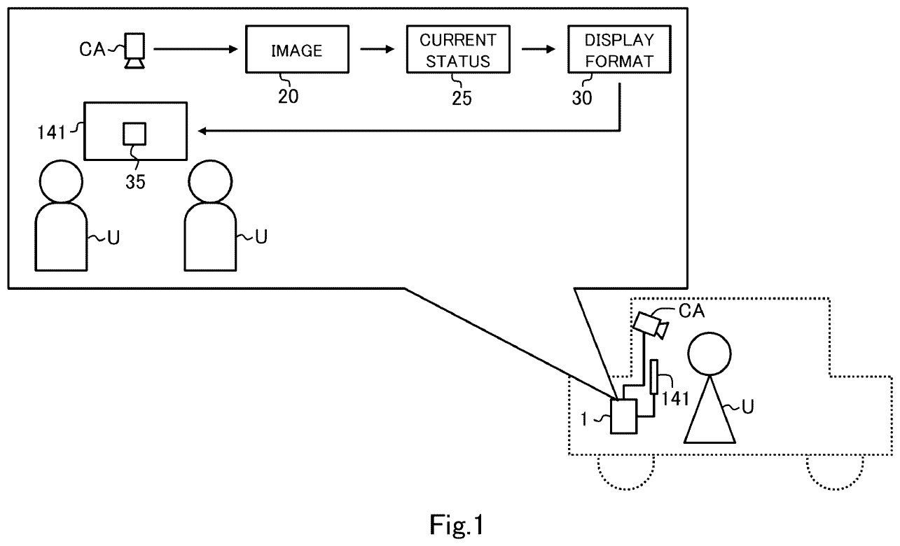

FIG. 1 schematically shows an example of a scene in which the present disclosure is applied. The in-vehicle device 1 according to the present embodiment is one or more computers configured to execute a process of displaying a two-dimensional code 35 on the display 141.

The in-vehicle device 1 according to the present embodiment acquires an image 20 from the imaging device CA disposed toward the inside of the vehicle. The in-vehicle device 1 identifies the current status 25 of the user U present in the vehicle by analyzing the acquired image 20. The in-vehicle device 1 determines the display format 30 of the two-dimensional code 35 according to the identified current status 25. Then, the in-vehicle device 1 displays the two-dimensional code 35 on the display 141 according to the determined display format 30.

In the present embodiment, the current status 25 in the vehicle is identified via the image 20 of the imaging device CA disposed toward the inside of the vehicle. Depending on the identified current status 25, the display format 30 of the two-dimensional code 35 is controlled. Thereby, the display of the two-dimensional code 35 suitable for the situation in the vehicle can be implemented. Therefore, according to the present embodiment, the readability of the two-dimensional code 35 can be improved.

### (In-vehicle Device/Imaging Device/Display)

The in-vehicle device 1 may be an in-vehicle device that is permanently installed in the vehicle T, or may be a user terminal that is installed in the vehicle T at least temporarily.

The imaging device CA may be provided in the in-vehicle device 1 or may be provided separately from the in-vehicle device 1. The imaging device CA may be permanently deployed in the vehicle T or may be temporarily deployed. If it is possible to image the inside of the vehicle T, the arrangement of the imaging device CA may not be particularly limited, and may be appropriately determined according to the embodiment. The imaging device CA may be fixed or movable. The type of imaging device CA may be arbitrarily selected. The imaging device CA may include any sensor that acquires data in an image or image representation, such as, for example, an RGB camera, a depth sensor, an infrared sensor, a radar, etc.

The display 141 may be provided in the in- vehicle device 1 or may be provided separately from the in-vehicle device 1. The display 141 may be permanently deployed in the vehicle T or may be temporarily deployed. If available to the user in the vehicle T, the arrangement of the display 141 may not be particularly limited and may be appropriately determined according to the embodiment. The display 141 may be fixed or movable. The type of display 141 may be arbitrarily selected. The display 141 may be a general display or a touch panel display.

### (Analysis)

The analysis content of the image 20 may be appropriately determined according to the embodiment. In one example, analyzing the image 20 may include detecting an object appearing in the image 20, estimating the position of the object, estimating the distance from the object, identifying the type of the object, and the like. The object may be, for example, a user, a reading device (reader) of the two-dimensional code, or the like. The user may be a vehicle occupant such as a driver or a passenger.

Further, the analysis method of the image 20 may be arbitrarily selected. In one example, the image 20 may be analyzed by a general image analysis method such as edge detection and pattern matching. In another example, the image 20 may be analyzed by a trained machine learning model that has acquired the ability to analyze the image. The machine learning model is configured to have one or more operational parameters that can be tuned by machine learning. One or more operational parameters are used to calculate the desired inference (in this embodiment, image analysis). The machine learning model may be configured by, for example, a neural network, a support vector machine, other functional expressions (arithmetic models), and the like. The machine learning method may be appropriately selected according to the machine learning model to be adopted (for example, error backpropagation method, etc.). Training a machine learning model comprises tuning (optimizing) the values of operational parameters with using training samples. The machine learning model may be appropriately trained to derive the true value of the corresponding analysis result when given an image of the training sample. A large-scale model such as a large visual language model (VLM: Vision Language Model) may be used as the trained machine learning model.

### (Current Status/Display Format)

If the display format 30 can be controlled, the identification content of the current status 25 may not be particularly limited, and may be appropriately determined according to the embodiment. In one example, the current status 25 of the user U may include the relative position of the user U with respect to the display 141, whether the user U is pointing the reading device to the display 141, and the like. The current status 25 of the user U may be identified directly from the user U detected in the image 20, or may be identified indirectly from an object other than the user U, such as a reading device held by the user U.

If the display format 30 can be controlled, the granularity for identifying the current status 25 may not be particularly limited, and may be appropriately determined according to the embodiment. In one example, the current status 25 of user U may be simply identified, such that an object that may correspond to user U exists on the right side of the display 141, exists on the left side, or the like. In another example, the current status 25 of the user U may be identified in detail, such as identifying the user U, estimating the distance to the user U, and the like.

The display format 30 of the two-dimensional code 35 defines the manner in which the two-dimensional code 35 is displayed on the display 141. The control item according to the display format 30 may be appropriately selected according to the embodiment. In one example, the item of the display format 30 may include settings that may be involved in the reading, such as output position on the display 141, display size, resolution, brightness, etc.

Further, the correspondence between the current status 25 and the display format 30 may be appropriately determined so that the user U of the identified current status 25 can be suitable for reading the two-dimensional code 35. For example, the in-vehicle device 1 may determine the display format 30 so as to display the two-dimensional code 35 in the area on the side of the display 141 where the user U is present. Also, for example, the in-vehicle device 1 may determine the display format 30 so that the closer the user U is to the display 141, the larger the two-dimensional code 35 is displayed, and the farther the user U is from the display 141, the smaller the two-dimensional code 35 is displayed or the normal size is displayed. Further, for example, the in-vehicle device 1 may determine the display format 30 so that the two-dimensional code 35 is displayed in a large size when the user U holds the reading device, and in a small or normal size when the reading device is not held. In one example, the in-vehicle device 1 may determine the display format 30 of the two-dimensional code 35 according to the current status 25 identified by at least one of the following first˜third control methods.

### (1) First Control Method

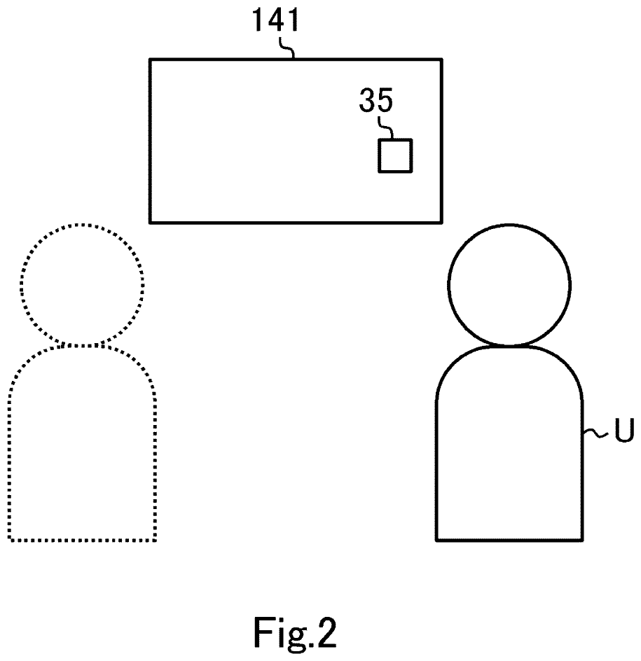

FIG. 2 schematically shows an example of a scene in which the display format 30 of the two-dimensional code 35 is controlled. In one example, the current status 25 may include the position of the user U relative to the display 141. The display format 30 may include setting the output position on the display 141. Determining the display format 30 may include determining the output position of the two-dimensional code 35 in the area on the user U side depending on the relative position. The area on the user U side may be closer to the user U on the display 141. In one example, the area on the user U side may be set in stages such as right, center, left, etc., or may be set continuously according to the detected direction of user U. In the example of FIG. 2, analysis of image 20 may identify that user U is present on the right side of the display 141. Accordingly, the output position of the two-dimensional code 35 may be set in the area on the right side of the display 141.

For example, if the display 141 is disposed between the driver's seat and the passenger's seat and the user U is sitting in the driver's seat (i.e., the user U is the driver), the output position of the two-dimensional code 35 may be set within the driver's side area of the display 141. Thereby, the two-dimensional code 35 may be displayed on the driver's side of the display 141. Further, for example, when the user U is sitting in the passenger seat, the output position of the two-dimensional code 35 may be set within the area on the passenger side of the display 141. Thereby, the two-dimensional code 35 may be displayed on the passenger side of the display 141. According to an example of the present embodiment, the two-dimensional code 35 can be displayed at a position close to the user U. Thereby, it is possible to reduce the amount of movement of the user U when reading the two-dimensional code 35.

In one example, the positional relationship between the imaging device CA and the display 141 may be specified in advance, such as the imaging device CA and the display 141 being installed in a predetermined position. In this case, the in-vehicle device 1 may identify the relative position of the user U with respect to the display 141 by detecting the user U in the image 20. In another example, when the installation position of the imaging device CA relative to the display 141 is unknown, the in-vehicle device 1 may identify the relative position of the user U with respect to the display 141 by detecting the display 141 and the user U in the image 20.

Further, the granularity for identifying the relative position may be appropriately determined according to the embodiment. In one example, the relative position may be simply identified, such that the user U is detected on the right side, detected in the center, detected on the left side, and the like in the image 20. That is, identifying the relative position may be configured by identifying the direction in which the user U exists with respect to the display 141. In another example, identifying the relative position may include estimating the distance from the display 141 to user U. The distance to the user U may be identified by a numerical value on a specific scale such as cm or m, or may be identified at a stepwise level such as far or near.

When estimating the distance to the user U, the in-vehicle device 1 may further use the estimated distance to determine the display format 30 of the two-dimensional code 35, or may determine the display format 30 regardless of the estimated distance. As an example of the former, the in-vehicle device 1 determines the output position of the two-dimensional code 35 on the display 141 according to the direction in which the user U exists with respect to the display 141, and the size of the two-dimensional code 35 according to the estimated distance. For example, if it is determined that the user U is closer to the display 141 than the threshold value by the identification result of the distance to the user U, the in-vehicle device 1 may determine the display format 30 to expand the size of the two-dimensional code 35. In other cases, the in-vehicle device 1 may determine the display format 30 so as to display the two-dimensional code 35 in a normal size. The normal and enlarged sizes may be determined accordingly. The display size may be controlled in two stages of normal and magnification, or may be controlled in three or more steps.

Further, when a plurality of user U is detected, the output position of the two-dimensional code 35 may be determined in any way. In one example, the output position of the two-dimensional code 35 may be set between a plurality of user U. One preferred person from a plurality of user U may be selected, and the output position of the two-dimensional code 35 may be set to the selected user U side. The method for selecting user U may be appropriately defined according to the embodiment. In one example, the preferred user U may be predefined as giving priority to the user in the passenger seat when there is a user in both the passenger seat and the driver's seat. In another example, the preferred user U may be selected by the second control method described later.

### (2) Second Control Method

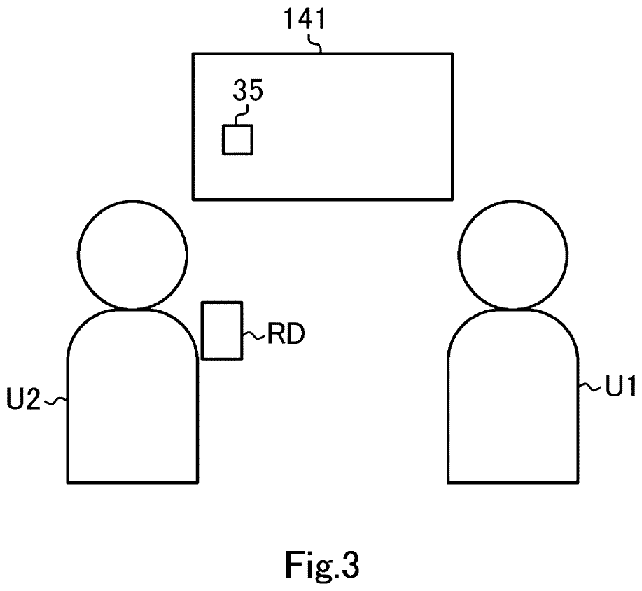

FIG. 3 schematically shows an example of a scene in which the display format 30 of the two-dimensional code 35 is controlled. In one example, when there is a plurality of user U in the vehicle, identifying the current status 25 of the user U may be configured by identifying the current status 25 of the user U that holds the reading device RD of the two-dimensional code 35 among the plurality of user U. That is, when a plurality of user U exists, the user U holding the reading device RD may be selected as the preferred user U, and the output position of the two-dimensional code 35 may be set to the user U side holding the reading device RD. In the example of FIG. 3, of the two users (U1, U2), the user U2 present on the left side holds the reading device RD. Accordingly, the output position of the two-dimensional code 35 may be set in the area on the left side of the display 141. According to an example of the present embodiment, a user U that is likely to read the two-dimensional code 35 can be selected from a plurality of user U using the retention of the reading device RD as an index. Thereby, it is possible to reduce the amount of movement when the selected user U reads the two-dimensional code 35.

In one example, the in-vehicle device 1 may identify a user U holding a reading device RD by detecting each user U in the image 20 and detecting the reading device RD. In another example, the in-vehicle device 1 may indirectly identify a user U who holds a reading device RD by detecting the reading device RD without detecting each user U. When a plurality of reading devices RD is detected, the output position of the two-dimensional code 35 may be determined in any way. In one example, the output position of the two-dimensional code 35 may be set between a plurality of reading devices RD. A priority reading device RD may be selected from a plurality of reading devices RD, and the output position of the two-dimensional code 35 may be set on the selected reading device RD side. The in-vehicle device 1 selects, for example, a reading device RD that satisfies conditions such as facing the display 141 or being closest to the display 141 from a plurality of reading devices RD, and the output position of the two-dimensional code 35 on the selected reading device RD side may be determined. The reading device RD may be, for example, a terminal including an imaging device, a dedicated device, or the like. The terminal including the imaging device may be, for example, a mobile terminal (including a smartphone), a tablet terminal, a notebook PC (Personal Computer), and the like.

### (3) Third Control Method

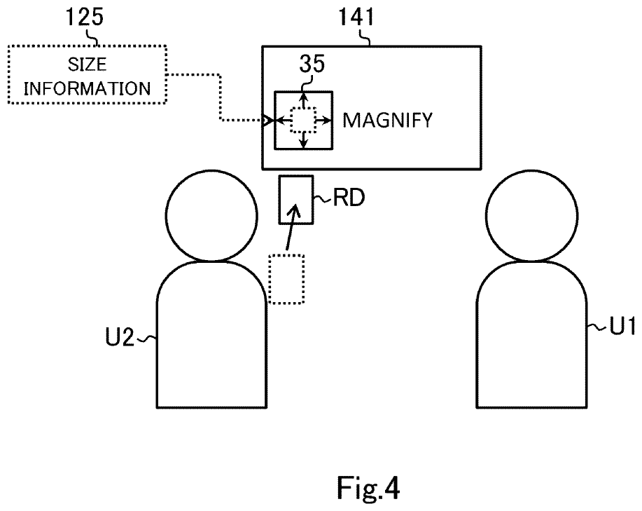

FIG. 4 schematically shows an example of a scene in which the display format 30 of the two-dimensional code 35 is controlled. In one example, the current status 25 may include whether or not the user U is directing the reading device RD to the display 141. The display format 30 may include a size setting of the two-dimensional code 35. Determining the display format 30 may include determining to increase the size of the two-dimensional code 35 when the user U is pointing the reading device RD relative to the display 141. In the example of FIG. 4, of the two users (U1, U2), the user U2 present on the left side is directing the reading device RD to the display 141. Accordingly, the output position of the two-dimensional code 35 may be set in the area on the left side of the display 141, and the size of the two-dimensional code 35 may be enlarged.

According to an example of the present embodiment, since the reading device RD is directed to the display 141, it is possible to detect a scene with a high probability that the reading of the two-dimensional code 35 will be performed. Then, at the detected scene, the size of the two-dimensional code 35 can be enlarged. Thereby, in a situation where there is a low probability that the two-dimensional code 35 is read, the display of other information can be prioritized (the display area of the display 141 can be saved). In addition, when reading the two-dimensional code 35, the readability can be improved by enlarging the two-dimensional code 35.

Note that the criteria for reading device whether or not the reading device RD is directed to the display 141 may be appropriately defined according to the embodiment. In one example, the mere detection of the reading device RD in the image 20 may be considered as the reading device RD being pointed towards the display 141. That is, the in-vehicle device 1 may determine that the reading device RD is pointed toward the display 141 in response to detection of the reading device RD. The in-vehicle device 1 may determine that the reading device RD is not directed to the display 141 in response to the fact that the reading device RD is not detected. Detecting even a portion of the reading device may be considered to detect reading device RD. Detecting the entire reading device may be considered to detect the reading device RD.

In another example, in the analysis of the image 20, the orientation of the reading device RD may be estimated. The in-vehicle device 1 may determine whether or not the reading device RD is directed to the display 141 according to the estimated orientation. The in-vehicle device 1 may detect a sensor (such as an imaging device) of the reading device RD in the analysis of the image 20. The in-vehicle device 1 may determine whether the reading device RD is pointed toward the display 141 or not depending on the detected position of the sensor and the orientation of the reading device RD.

In yet another example, in the analysis of the image 20, the distance from the display 141 to the reading device RD may be estimated. The distance to the reading device RD may be estimated in numerical values on a specific scale or at a stepwise level. The in-vehicle device 1 may determine that the reading device RD is directed to the display 141 according to the estimated distance being less than the threshold value. The in-vehicle device 1 may determine that the reading device RD is not directed at the display 141 according to the estimated distance exceeding the threshold value. If the estimated distance is equal to the threshold value, the In-vehicle device 1 may be determined in any way.

Further, the display size of the two-dimensional code 35 at the time of enlargement may be appropriately determined according to the embodiment. In one example, the in-vehicle device 1 may refer to size information 125 indicating the size of the display 141. The in-vehicle device 1 may determine the display size of the two-dimensional code 35 at the time of enlargement so that it has a display size of a predetermined size or more within the display 141 of the size indicated in the size information 125. In another example, the in-vehicle device 1 may enlarge the two-dimensional code 35 at a predetermined magnification without referring to the size information 125. The magnification factor at the time of enlargement may be arbitrarily specified. The display size of the two-dimensional code 35 during normal times may also be appropriately determined according to the embodiment. The display size may be controlled in two stages of normal and magnification, or may be controlled in three or more steps. When the display size of the two-dimensional code 35 is controlled in three or more stages, the display size at each stage may be appropriately determined according to the embodiment.

### (Two-Dimensional Code)

The information held in the two-dimensional code 35 may not be particularly limited and may be appropriately selected according to the embodiment. In one example, the information held in the two-dimensional code 35 may include navigation information such as facility information about facilities existing in the vicinity of the vehicle T. The facility may be, for example, a store, a rest facility, or the like. The information held in the two-dimensional code 35 may include any information obtained via the network. The information held in the two-dimensional code 35 may also include vehicle information about the vehicle T. The vehicle information may include, for example, position information of the vehicle T, the remaining amount of fuel, the number of vacant seats, the temperature inside the vehicle, the image inside the vehicle, and the like. The remaining amount of fuel may be, for example, the amount of gasoline, the remaining amount of the battery (state of charge), and the like. The two-dimensional code 35 displayed may be switched arbitrarily. Further, the two-dimensional code 35 may be displayed in response to any event such as operator operation or the proximity of the vehicle T to the target facility. The two-dimensional code 35 is configured to have information horizontally and vertically. The type of two-dimensional code 35 may be arbitrarily selected from a matrix type, a stack type, or the like.

### 2 Configuration Example

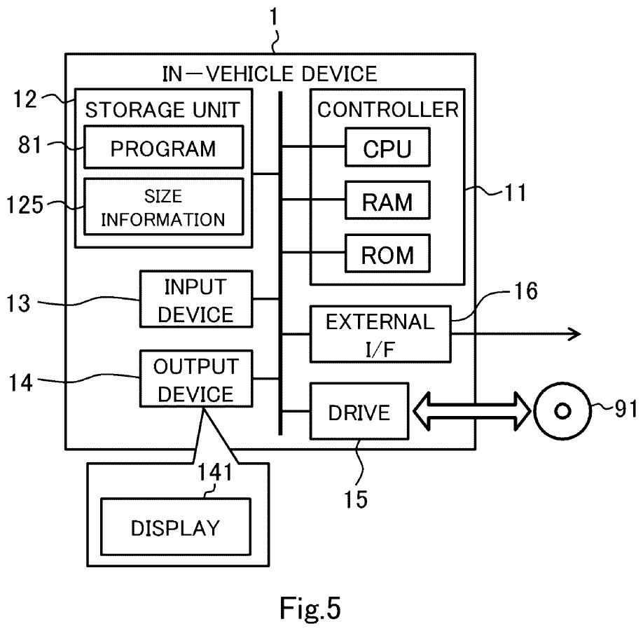

FIG. 5 schematically shows an example of the hardware configuration of the In-vehicle device 1 according to the present embodiment. The In-vehicle device 1 according to the present embodiment is a computer to which the controller 11, the storage unit 12, the input device 13, the output device 14, the drive 15, and the external interface 16 are electrically connected.

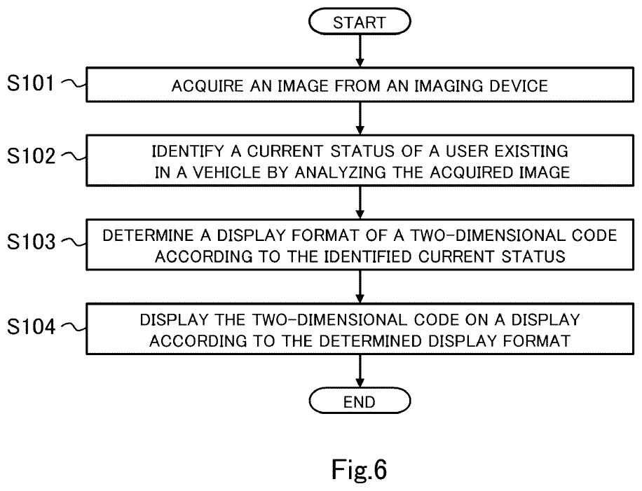

The controller 11 includes a CPU (Central Processing Unit), RAM (Random Access Memory), ROM (Read Only Memory), and the like, and is configured to execute arbitrary information processing based on a program and various data. The controller 11 (CPU) is an example of a processor resource. The storage unit 12 may be configured by, for example, any storage device such as a hard disk drive, a solid-state drive, or a semiconductor memory. The storage unit 12 (and RAM, ROM) is an example of a memory resource. In the present embodiment, the storage unit 12 stores various information such as a program 81 and size information 125. The program 81 is a program for causing the in-vehicle device 1 to execute information processing (FIG. 6 described later) for the display of the two-dimensional code 35. The program 81 includes a series of instructions for the processing of the information.

The input device 13 is a device for inputting information such as an operation button and a microphone, for example. The output device 14 is a device for outputting information such as a speaker, for example. In the present embodiment, the output device 14 includes a display 141. An operator such as user U can operate the in-vehicle device 1 by using the input device 13 and the output device 14. The input device 13 and the output device 14 (display 141) may be integrally configured by, for example, a touch panel display or the like. At least one of the input device 13 and the output device 14 may be connected via the external interface 16.

The drive 15 is a device for reading various information such as programs stored on the storage medium 91. At least one of the program 81 and the size information 125 may be stored on the storage medium 91 instead of or together with the storage unit 12. The storage medium 91 is configured to store the information by electrical, magnetic, optical, mechanical or chemical action so that a machine such as a computer can read various information (such as a stored program). The in-vehicle device 1 may acquire at least one of the program 81 and the size information 125 from the storage medium 91. The storage medium 91 may be a disk-type storage medium such as a CD or DVD, or a storage medium other than a disk-type such as a semiconductor memory (for example, flash memory). The type of drive 15 may be appropriately selected according to the type of storage medium 91.

The external interface 16 is configured to connect to an external device in a wired or wireless manner. The external interface 16 may be configured by, for example, a USB (Universal Serial Bus) port, a dedicated port, a communication port, and the like. When the external interface 16 includes a communication port, the communication standard of the communication port may be arbitrarily selected. In the present embodiment, the in-vehicle device 1 may be connected to the imaging device CA via the external interface 16. Note that the connection method of the imaging device CA may not be limited to such examples, and may be appropriately changed according to the embodiment. In another example, the in-vehicle device 1 may include an imaging device CA as one of the components. The in-vehicle device 1 may be connected to the imaging device CA via another computer.

With regard to the specific hardware configuration of the in-vehicle device 1, the component can be omitted, replaced, and added as appropriate according to the embodiment. For example, the controller 11 may include a plurality of hardware processors. The hardware processor may be composed of a microprocessor, a field-programmable gate array (FPGA), a digital signal processor (DSP), an electronic control unit (ECU), a graphics processing unit (GPU), an application specific integrated circuit (ASIC), etc. The drive 15 may be omitted. The in-vehicle device 1 may be a mobile terminal (including a smartphone), a tablet terminal, a general-purpose PC, or the like in addition to a computer designed specifically for the purpose.

### 3 Operation Example

FIG. 6 is a flowchart illustrating an example of a processing procedure related to the display of a two-dimensional code 35 by the in-vehicle device 1 according to the present embodiment. The controller 11 of the in-vehicle device 1 executes the instructions included in the program 81 by the CPU. Thereby, the in-vehicle device 1 operates as a computer capable of executing the information processing of FIG. The following processing procedure is an example of an information processing method executed by a computer (in-vehicle device). However, the following processing procedure is only an example, and each step may be modified as much as possible. In addition, steps in the following processing procedure can be omitted, replaced, or added as appropriate depending on the embodiment.

In step S101, the controller 11 acquires an image 20 from the imaging device CA. Upon acquiring the image 20, the controller 11 proceeds with the process to the next step S102.

In step S102, the controller 11 identifies the current status 25 of the user U existing in the vehicle T by analyzing the acquired image 20.

In one example, the controller 11 may obtain an analysis result of the current status 25 of the user U by analyzing the image 20 by a general image analysis method. In another example, the controller 11 may input the acquired image 20 to the trained machine learning model and perform arithmetic processing of the trained machine learning model. Thereby, the controller 11 may obtain an output corresponding to the analysis result of the current status 25 from the trained machine learning model.

In one example, the controller 11 may identify the relative position of the user U with respect to the display 141 as at least a part of the current status 25 in the analysis of the captured image 20. In one example, when there is a plurality of user U in the vehicle T, the controller 11 may identify the current status 25 of the user U holding the reading device RD of the two-dimensional code 35 among the plurality of user U. In one example, the controller 11 may identify whether or not the reading device RD is directed to the display 141 as at least a part of the current status 25 in the analysis of the image 20. Upon identifying the current status 25, the controller 11 proceeds with the process to the next step S103.

In step S103, the controller 11 determines the display format 30 of the two-dimensional code 35 according to the identified current status 25.

In one example, the display format 30 may include setting an output position on the display 141. The controller 11 may determine the output position of the two-dimensional code 35 in the area on the user U side on the display 141 according to the identified relative position. In one example, when a plurality of user U are present, the controller 11 may determine the output position of the two-dimensional code 35 in the area on the user U side holding the reading device RD. In one example, the display format 30 may include setting the size of the two-dimensional code 35. When the reading device is directed to the display 141, the controller 11 may decide to increase the size of the two-dimensional code 35. When the display format 30 is determined, the controller 11 proceeds to the next step S104.

In step S104, the controller 11 displays the two-dimensional code 35 on the display 141 in accordance with the determined display format 30.

In one example, the controller 11 may display a two-dimensional code 35 closer to the user U. In one example, when a plurality of user U exists, the controller 11 may display a two-dimensional code 35 closer to the user U holding the reading device RD. In one example, when the reading device RD is directed to the display 141, the controller 11 may enlarge the two-dimensional code 35 and display it on the display 141. When the display of the two-dimensional code 35 is completed, the controller 11 ends the processing procedure according to the present operation example.

Note that the controller 11 may acquire information on the two-dimensional code 35 to be displayed in response to an arbitrary event such as operator operation or condition fulfillment (proximity to the target facility, etc.). The controller 11 may execute a series of processes from step S101 to step S104 in response to being given the two-dimensional code 35 to be displayed. The controller 11 may execute a series of processes of steps S101˜S104 in real time.

Further, while the same two-dimensional code 35 is displayed, the controller 11 may repeatedly execute a series of processes of steps S101˜S104 periodically or irregularly. Thereby, the controller 11 may track the current status 25 of the user U, and may update the display format 30 of the two-dimensional code 35 in real time according to the tracked current status 25.

### [Features]

In the present embodiment, the current status 25 of the user U existing in the vehicle is identified by the processing of steps S101˜S103, and the display format 30 of the two-dimensional code 35 is controlled according to the identified current status 25. Thereby, the display of the two-dimensional code 35 suitable for the situation in the vehicle can be implemented.

Therefore, according to the present embodiment, the readability of the two-dimensional code 35 can be improved.

### 4 Modifications

As described above, embodiments of the present disclosure have been described in detail, but the description up to the above is only an example of the present disclosure in all respects. The processes and means described in the present disclosure can be freely combined and implemented insofar as no technical contradictions arise. In the above embodiment, various improvements or modifications may be made as appropriate.

What is claimed is:

1. An in-vehicle device comprising a controller configured to execute:
acquiring an image from an imaging device disposed toward an inside of a vehicle;
identifying a current status of a user present in the vehicle by analyzing the acquired image;
determining a display format of a two-dimensional code according to the identified current status; and
displaying the two-dimensional code on a display according to the determined display format.

2. The in-vehicle device according to claim 1, wherein
the current status includes a relative position of the user to the display,
the display format includes a setting of an output position on the display;
the determining the display format includes determining the output position of the two-dimensional code within a user side area according to the relative position.

3. The in-vehicle device according to claim 2, wherein
when there is a plurality of users in the vehicle, the identifying the current status of the user comprises identifying the current status of a user holding a reading device of the two-dimensional code among the plurality of users.

4. The in-vehicle device according to claim 3, wherein
the current status includes whether or not the user is pointing the reading device toward the display,
the display format includes setting a size of the two-dimensional code;
determining the display format includes determining to increase the size of the two-dimensional code when the user is pointing the reading device toward the display.

5. A non-transitory storage medium storing a program for causing an in-vehicle device to execute an information processing method,
wherein the information processing method includes:
acquiring an image from an imaging device disposed toward an inside of a vehicle;
identifying a current status of a user present in the vehicle by analyzing the acquired image;
determining a display format of a two-dimensional code according to the identified current status; and
displaying the two-dimensional code on a display according to the determined display format.
